(19) United States
(12) Patent Application Publication
(10) Pub. No.: US 2009/0079834 A1
(43) Pub. Date: Mar. 26, 2009

(54) CAMERA

(75) Inventor: Hironao Otsu, Hachioji-shi (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 12/328,051

(22) Filed: Dec. 4, 2008

Related U.S. Application Data
(63) Continuation of application No. PCT/JP2007/071057, filed on Oct. 29, 2007.

(30) Foreign Application Priority Data
Nov. 20, 2006 (JP) 2006-313354

(51) Int. Cl. H04N 5/225

(52) U.S. Cl. 348/169; 348/360; 348/E05.022

(57) ABSTRACT

A camera of the present invention is provided with a gapless prism which obtains wavelength spectrum of an optical image of a targeting object, an IR-cut filter which is inserted to and retreated from an optical path, and a Bch image sensor, a Gch image sensor, and an Rch+IR image sensor which are arranged for respective spectrum separated by the gapless prism. An infrared ray separator which conducts separation into a specific spectrum signal and an infrared ray signal from infrared ray mixture image data output from the Rch+IR image sensor when the IR-cut filter is retreated from the optical path.

### CROSS REFERENCE TO RELATED APPLICATIONS

This is a Continuation Application of PCT Application No. PCT/JP2007/071057, filed Oct. 29, 2007, which was published under PCT Article 21(2) in Japanese.

This application is based upon and claims the benefit of priority from prior Japanese Patent Application No. 2006-313354, filed Nov. 20, 2006, the entire contents of which are incorporated herein by reference.

### BACKGROUND OF THE INVENTION

1. Field of the Invention

The present invention relates to a camera, and more specifically to a camera which captures a targeting object under a low illuminance utilizing infrared rays.

2. Description of the Related Art

For example, JP-A-08-275182 discloses a technique regarding a television camera for joint color mode-infrared mode use which can use an infrared beam falling within a wavelength region apart from a visible region to perform imaging in a separating manner from beam within the visible region at a time of infrared mode imaging by using a color separation optical system comprising a simple film configuration.

The television camera for joint color mode-infrared mode use described in JP-A-08-275182 is a television camera for joint color joint mode-infrared mode use which conducts color separation of beam from a subject which has passed through an objective lens to three color-lights of at least blue light, red light, and green light via a color separation optical system to guide the color-lights to imaging elements corresponding to the three color-lights and conducts switching between color mode imaging and infrared mode imaging by attaching/detaching an infrared ray blocking filter which blocks infrared rays or an infrared ray transmission filter which allows transmission of infrared rays in an optical path between the subject and the imaging elements, where the color separation optical system comprises at least three prism blocks, a portion of a transmission and reflection face of a prism block of the three prism blocks which beam from the subject enters is applied with a blue reflection dichroic film which reflects blue light and infrared light on a part of the transmission and reflection face and allows transmission of the remaining color-lights, the blue reflection dichroic film includes, as a basic film configuration, alternating layers of at least twelve layers comprising high refractive index layer films and low refractive index layer films, where an optical film thickness ratio of the high refractive index layer film and the low refractive index layer film is 3:1, and switching between the color mode imaging and the infrared ray mode imaging is performed by taking out a signal taken out of the blue color imaging element as a blue signal for a color image when the infrared ray blocking filter is inserted into the optical path and taking out a signal taken out of the blue color imaging element as a signal for an infrared image when the infrared ray blocking filter is removed from the optical path and the infrared ray transmission filter is inserted into the optical path.

### BRIEF SUMMARY OF THE INVENTION

In the television camera for joint color mode-infrared mode use described in the abovementioned JP-A-08-275182, the technique of performing switching between the color mode imaging and the infrared mode imaging by attaching/detaching the infrared ray blocking filter which blocks infrared rays or the infrared ray transmission filter which allows infrared rays in the optical path between the subject and the imaging elements is described. An object of the technique described in JP-A-08-275182 is to be capable of using infrared beam within a wavelength region apart from a visible region to perform imaging (imaging of an infrared image) in a separating manner from beam within the visible region at an infrared mode imaging time by properly setting deposition substance used for the blue reflection dichroic film reflecting blue color light and infrared light and a configuration of the film and using a color separation optical system comprising a simple film configuration.

However, the television camera for joint color mode-infrared mode use described in the abovementioned JP-A-08-275182 is a camera with a common use configuration which allow imaging even in an infrared ray region, but an image captured at a time of infrared mode is a monochrome image and JP-A-08-275182 does not include any description about a mixed mode of the color mode and the infrared mode.

Accordingly, an object of the present invention is to provide a camera with an optical prism which can obtain a color-reproducible image even in case that image captured to a targeting object under a low illuminance is preformed utilizing infrared rays.

Accordingly, an object of the present invention is to provide a camera comprises:
an optical prism which obtains wavelength spectrum of an optical image of a targeting object;
an infrared ray cutting filter which is set to and retreated from an optical path from the targeting object to the optical prism; and
a plurality of image sensor arranged for respective wavelengths which have been separated by the optical prism, wherein
one of the image sensors has an infrared ray mixture image sensor which receives both a specific spectrum and infrared rays, and
an infrared ray separator which separates infrared ray mixture image data output from the infrared ray mixture image sensor into a specific spectrum signal and an infrared ray signal when the infrared ray cutting filter is retreated from the optical path is provided.

### BRIEF DESCRIPTION OF THE SEVERAL VIEWS OF THE DRAWING

FIG. 1 is a block diagram showing a configuration of an electric system of a camera according to an embodiment of the present invention;

FIG. 2 is a diagram showing a configuration example of an optical block according to the embodiment of the present invention;

FIG. 3 is a graph showing an amount of photoelectric conversion for each channel where an image of white has been captured in the camera according to the embodiment of the present invention;

FIG. 4 is a graph showing a white balance adjustment section of the camera according to the embodiment of the present invention; and

FIG. 5 is a diagram showing one example of a color vector adjustment section of the camera according to the embodiment of the present invention.

### DETAILED DESCRIPTION OF THE INVENTION

Embodiments of the present invention will be explained below with reference to the drawings.

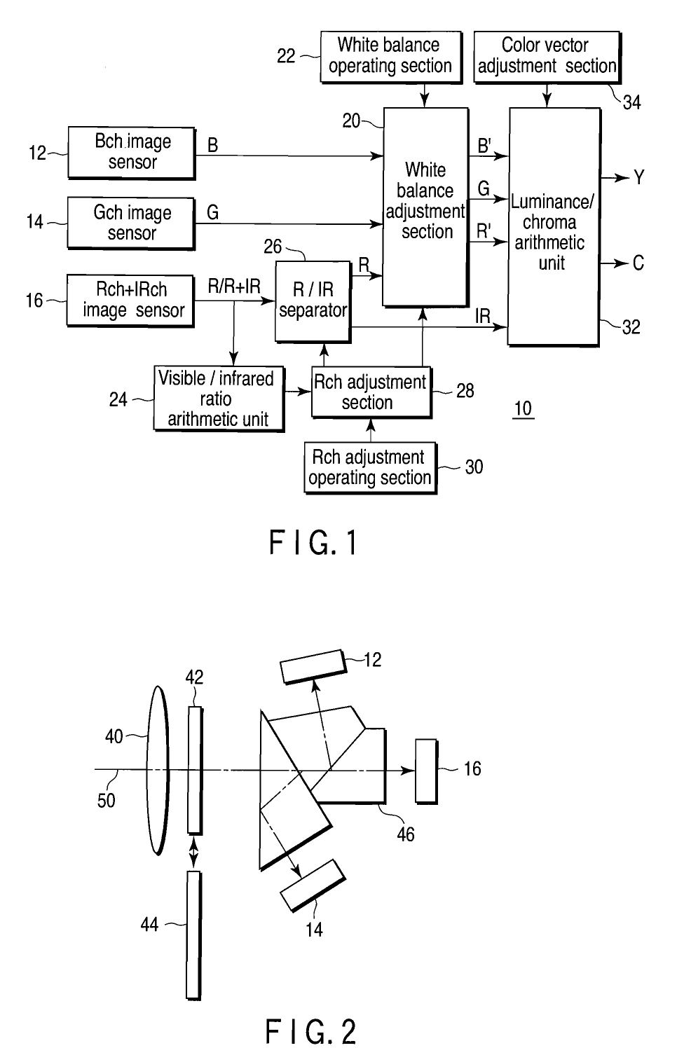

FIG. 1 is a block diagram showing a configuration of an electric system of a camera according to an embodiment of the present invention.

In FIG. 1, a camera 10 comprises a blue channel (Bch) image sensor 12 for blue color (B), a green channel (Gch) image sensor 14 for green color (G), a red channel and infrared ray channel (Rch+IRch) image sensor 16 for red color (R) serving as an infrared mixture image sensor, a white balance adjustment section 20, a white balance operating section 22, a visible/infrared ratio arithmetic unit 24, an R/IR separator 26, an Rch adjustment section 28, an Rch adjustment operating section 30, a luminance/chroma arithmetic unit 32, and a color vector adjustment section 34.

The camera 10 with such a configuration emits infrared rays to a targeting object (not shown) under a low illuminance to reflect an infrared ray reflectance of the targeting object to luminance of image data. Since the camera 10 is configured such that functions of both the Rch image sensor and the IRch image sensor are conducted by one image sensor, when a targeting object under a low illuminance is captured utilizing infrared rays, an R+IR signal is output from the Rch+IRch image sensor 16. A separating method of the R+IR signal is configured to set a separation boundary value between an R signal and an IR signal based upon white balance of R, G, B and color balance to separate the R+IR signal into the R signal and the IR signal based upon the separation boundary value. As a setting method of the separation boundary value, there are manual adjustment and automatic adjustment which will be described in detail later.

FIG. 2 is a diagram showing a configuration example of an optical block according to an embodiment of the present invention.

In FIG. 2, the optical block comprises a lens 40, a dummy lens 42, an IR-cut filter 44, a gapless prism 46, a Bch image sensor 12, a Gch image sensor 14, and an Rch+IRch image sensor 16. The abovementioned IR-cut filter 44 is provided so as to be capable of advancing to and retreating from an optical path 50 from a targeting object (not shown) to the gapless prism 46 via the lens 40. The abovementioned Bch image sensor 12, Gch image sensor 14, and Rch+IRch image sensor 16 are connected like the configuration of the camera 10 shown in FIG. 1.

In FIG. 2, the gapless prism 46 where no gap is provided between prism members is used as one example, but a gap type prism may be used depending on an application of the camera. A merit of using the gapless prism 46 includes a point that an optical prism can be reduced in size and a point that wavelength spectrum with a combined Rch and Irch can be achieved easily by simply removing the IR-cut filter 44 from the optical path 50. In FIG. 2, the image sensor 16 has both functions of Rch and IRch, but it is unnecessary to limit a color to be combined with IRch to Rch. However, when designing is performed regarding the Rch+IRch image sensor 16 provided with both the Rch and the IRch, an image sensor with preferential sensitivity of long wavelength can be used only for the Rch+IRch image sensor 16.

Next, the white balance adjustment section 20 shown in FIG. 1 will be explained.

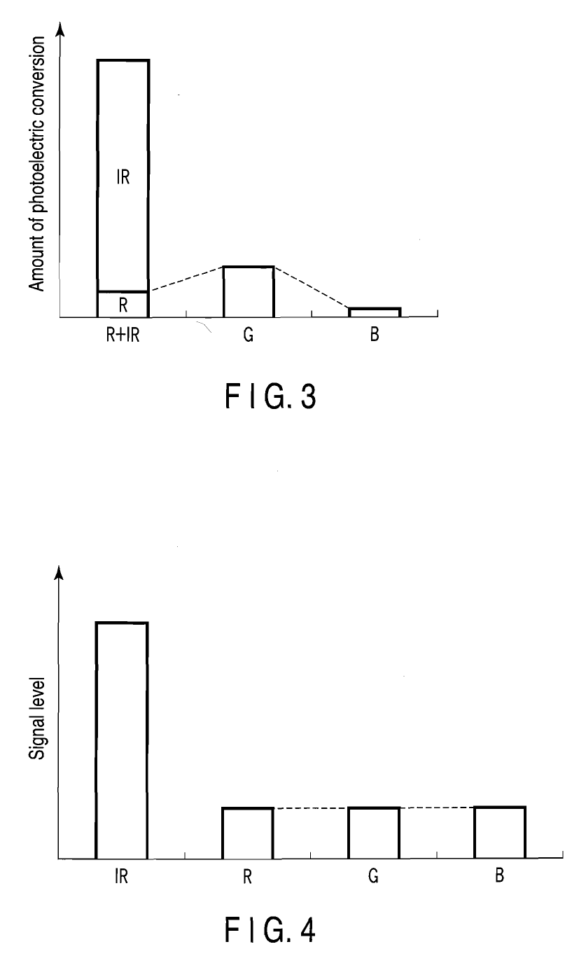

A B signal output from the Bch image sensor 12, a G signal output from the Gch image sensor 14 and an R signal obtained by separating an R+IR signal output from the Rch+IRch image sensor 16 in the R/IR separator 26 is adjusted regarding its white balance by the white balance adjustment section 20. The white balance will be explained with reference to FIG. 3 and FIG. 4.

FIG. 3 is a graph showing an amount of photoelectric conversion for each channel (ch) where white has been detected in the camera according to an embodiment of the present invention. Alternatively, the FIG. 3 may be a graph showing a relative amount of photoelectric conversion for each channel acquired from a white balance detective area set within effective pixels of an image sensor.

As shown in FIG. 3, in an amount of photoelectric conversion acquired from the R+IR image sensor 16, Rch and IRch are not separated from each other, where they are present in a mixed manner. Therefore, in the camera 10 according to the present embodiment, it is necessary to separate the R signal and the IR signal mixed in the Rch+IRch image sensor 16 using the R/IR separator 26 to perform adjustment of white balance.

The abovementioned R/IR separator 26 is provided so as to separate an R signal and an IR signal configuring infrared ray mixed image data, which are present in the Rch+IRch image sensor 16 serving as an infrared ray mixture image sensor in a mixed manner, into a specific spectrum signal (R signal) and an infrared ray signal (IR signal). As shown in FIG. 1, it is understood that the R/IR separator 26 is connected with the Rch adjustment section 28.

The Rch adjustment section 28 is a specific spectrum adjustment section for setting a separation boundary value between the specific spectrum signal and the infrared ray signal from an infrared ray mixture image. The separation boundary value between the R signal and the IR signal is set by the Rch adjustment section 28, so that R signal and the IR signal are separated from each other. After the R signal and the IR signal are separated from each other, multiplication of white balance gain should be performed such that approximate coincidence of signal levels of respective color signals of R, G, and B can be obtained.

There is manual adjustment and automatic adjustment in the Rch adjustment section 28, and when the manual adjustment is performed, after coarse adjustment of Rch is performed based on color balance of the whole image frame and white balance is re-adjusted, fine adjustment of Rch may be performed again. The automatic adjustment will be described later.

When the white balance is adjusted manually, the adjustment is performed by the white balance operating section 22 shown in FIG. 1. As one example of an operating member, there are a dial, a lever, a button, or the like.

FIG. 4 is a graph showing a signal level in the white balance adjustment section 20 of the camera according to an embodiment of the present invention.

In FIG. 4, a white balance gain of a G signal is fixed to ×1 time as one example of the white balance adjustment, which is because a circuit scale of the white balance adjustment section 20 has been considered, and the gain should not be fixed to ×1 time necessarily. However, as shown in FIG. 4, when only the R signal and the B signal is multiplied by the white gain, such a feature can be obtained that the ratio of the IR signal and the G signal to each other is maintained.

In addition, as shown in FIG. 1, IR signal has not to be input to the white balance adjustment section 20, this is because there is no color information in the IR signal.

As shown in FIG. 1, the luminance/chroma arithmetic unit 32 will be explained.

Regarding the luminance arithmetic unit 32, such a configuration can be adopted that an ordinary luminance Y matrix is multiplied by visible light favorite coefficient k and the multiplication result is added with an IR component.

Y=I+k(r×R+g×G+b×B) (1)

Here, I represents a signal level of an IR signal. The symbols, k, r, g, and b are positive real numbers.

Regarding the Y matrix (r, g, b), it is thought that there are various applications, and, for example, the Y matrix (r, g, b) can be set based upon the RGB spectrum sensitivity ratio multiplied by a lens, a prism, an optical filter, and an image sensor when white of a standard light source has been detected. For example, as the result that 3200K is set to a color temperature of the standard light source, if the RGB spectrum sensitivity ratio approximately coincides with (3:6:1), the Y matrix coefficient may be set to (3:6:1).

Y=I+k(0.3×R+0.6×G+0.1×B) (2)

Further, for example, as the result that 5600K is set to a color temperature of the standard light source, if the RGB spectrum sensitivity ratio approximately coincides with (2:7:1), the Y matrix coefficient may be set to (2:7:1).

Y=I+k(0.2×R+0.7×G+0.1×B) (3)

In such a case that the luminance signal-to-noise ratio varies according to change of the image captured condition (gain) or the image processing conditions (a noise cancelling coefficient, reading of an image frame), a classification fuzzy function f(χ) based upon, for example, the image processing conditions may be used instead of the visible light favorite coefficient k.

Y=I+f(χ)×(r×R+g×G+b×B) (4)

Here, χ is the image captured condition (gain).

Regarding the chroma arithmetic unit, a hue and a saturation can be calculated from (R′, G, B′) shown in FIG. 1. In the chroma arithmetic unit, the IR signal is not used. This is because color information is not contained in the IR signal. A signal level balance between the luminance Y and the chroma C is important regarding color reproducibility, and when gradation property processing is applied to the luminance Y, similar gradation property processing should be applied to the chroma C based upon luminance gradation property.

Next, the abovementioned Rch adjustment operating section 30 will be explained.

The Rch adjustment operating section 30 and the visible/infrared ratio arithmetic unit 24 are connected to the Rch adjustment section 28. The Rch adjustment operating section 30 is a specific spectrum adjustment operating section, which is a manual adjustment operating section by which a user determines a separation boundary value between an R signal and an IR signal while he/she is watching an output video. As one example of an operating member for the Rch adjustment operating section 30, there are a dial, a lever, a button, or the like.

Next, the visible/infrared ratio arithmetic unit 24 will be explained.

The visible/infrared ratio arithmetic unit 24 is an arithmetic unit which conducts mutual taking-out and putting-in of the dummy lens 42 and the IR-cut filter 44 shown in FIG. 2 regarding one scene with which a light source of a targeting object approximately coincides to conduct image captured individually and calculates a visual/infrared ratio of an R signal and an IR signal output by the Rch+IRch image sensor 16. That is, the visible/infrared ratio arithmetic unit 24 is an arithmetic unit which defines a separation boundary value between the R amount of photoelectric conversion and the IR amount of photoelectric conversion shown in FIG. 3, and an object thereof is to conduct automatic adjustment of Rch adjustment.

Here, the dummy lens 42 shown in FIG. 2 is a lens which allows transmission of both visible light and infrared rays therethrough. An optical path length of the dummy lens 42 approximately coincides with an optical path length of the IR-cut filter 44. Incidentally, when the optical path length of the IR-cut filter 44 is negligible, the camera 10 is not always provided with the dummy lens 42.

Thus, in the configuration of the camera 10 shown in FIG. 1, the Rch adjustment operating section 30 and the visible/infrared ratio arithmetic unit 24 are connected to the Rch adjustment section 28 in parallel. Therefore, the camera 10 can adopt such a two-stage adjustment that, after coarse adjustment of the Rch ratio is performed in the visible/infrared ratio arithmetic unit 24, fine adjustment of the Rch ratio is performed in the Rch adjustment operating section 30.

In the camera 10 according to the present embodiment, manual adjustment of white balance can be performed so as to meet a user's preference by the white balance operating section 22 shown in FIG. 1. When a user adjusts white balance by manual operation, it is not always that the white balance coincides with the solution of white balance as shown in FIG. 4. This is because quantitative white may be different from qualitative white favored by a user.

When the Rch adjustment has been conducted after white balance adjustment, the white balance should be maintained in linkage with fluctuation of the separation boundary value between the R signal and the IR signal. As one example, it is considered that a circuit configuration which increases/decreases a Rch while balance gain in inverse proportion to an increase/decrease ratio of the separation boundary value of the R signal is provided within the white balance adjustment section 20 shown in FIG. 1.

For reflecting the fluctuation of the separation boundary value of the R signal to the white balance adjustment section 20, it is desirable that the Rch adjustment section 28 and the white balance adjustment section 20 are connected to each other.

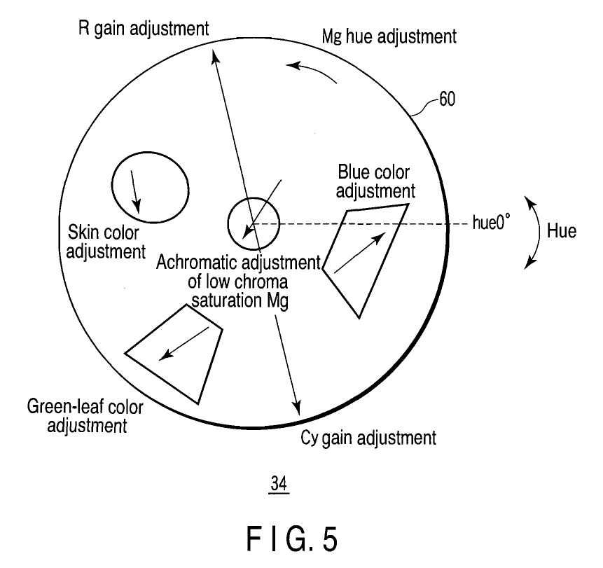

Next, the color vector adjustment section 34 according to the present embodiment will be explained with reference to FIG. 5.

As shown in FIG. 5, the color vector adjustment section 34 is one for conducting color correction in a concept on a vector scope within a vector display frame 60, and it is not always required to conduct vector display. However, when the vector display is performed, adjustment operability which easily coincides with visual characteristic of human intuitively can be obtained.

As one example of the color vector adjustment section 34, there are R gain adjustment, Cy gain adjustment, Mg hue adjustment, achromatic adjustment of low chroma saturation Mg (adjustment for further reducing magenta color with low chroma saturation to lower chroma saturation), skin color adjustment, green-leaf color adjustment, blue color adjustment, and the like. The abovementioned Rch adjustment section 28 conducts adjustment so as to roughly satisfy the whole color tone, and color correction processing rich regarding expression can be made possible by using the color vector adjustment section 34 instead of the Rch adjustment section 28 in order to achieve finer color expression.

Incidentally, as a displaying method other than the vector display, for example, such a configuration can be adopted that each adjustment item is caused to be displayed using a band graph and an adjustment amount is represented at a break position of a band-like rectangular shape.

The color vector adjustment section 34 shown in FIG. 5 may be connected to the luminance/chroma arithmetic unit 32 like the color vector adjustment section 34 shown in FIG. 1. The color vector adjustment section 34 may be displayed by a dedicated vector display section, it may be superimposed with a vector signal on a video output section, it may be displayed in an EVF (electronic view finder) in a superimposing manner, or it may be displayed in a switching manner.

Regarding goodness/badness of color reproducibility of an image to a user, it is not always that a user prefers quantitative color reproduction, and the user may prefer an expected color or a memory color. The user may desire to conduct adjustment to a color on video expression. Therefore, it is preferable that the color vector adjustment section 34 shown in FIG. 5 is present as a configuration different from the Rch adjustment section 28.

The luminance signal-to-noise ratio on a noise meter may degrade according to increase of the visible light favorite coefficient k described by the abovementioned Equation (1), and it is considered that there is a scene where a color vector adjustment section is essential, especially, for a targeting object of 0.1 luxes or less.

Incidentally, such a configuration can be adopted that adjustment operation for the visible light favorite coefficient k described by the abovementioned Equation (1) is assembled in the color vector adjustment section 34 so that a user can conduct adjustment of the visible light favorite coefficient k and the color vector adjustment manually in a linking manner. As one example of an adjustment operating member of the visible light favorite coefficient k, there are a dial, a lever, a button, a touch panel, or the like.

As described above, the camera according to the present embodiment is a camera having an optical prism where, even if a targeting object under a low illuminance is captured utilizing infrared rays, the separation boundary value between the R signal and the IR signal is determined by the Rch adjustment section 28 and the R signal and the IR signal are separated from each other by the R/IR separator 26, so that a video signal (Y, C) with color reproducibility can be obtained.

Incidentally, in case of the ordinary capturing mode is performed utilizing only visible light instead of image captured a targeting object under low illuminance, such an operation can be adopted that the IR-cut filter 44 shown in FIG. 2 is attached onto the optical path 50 and the dummy lens 42 is removed from the optical path 50. Such a configuration may be adopted that the R signal passes through the R/IR separator 26 shown in FIG. 1 without being influenced by the R/IR separator 26 at a time of the ordinary capturing mode.

Incidentally, the camera of the present invention can be applied to a TV camera, a cinema camera, a movie camera for contents production, a still camera, a monitoring camera, a security camera, a measuring instrument, a medical camera, and the like.

The embodiment of the present invention has been described above in detail with reference to the drawings, but a specific configuration thereof is not limited to the embodiment and design variations without departing from the gist of the present invention can be included in the present invention.

Further, inventions at various stages are included in the abovementioned embodiment, and various inventions can be extracted according to proper combinations of a plurality of constituent elements disclosed here. For example, even if several constituent requirements are removed from all the constituent requirements shown in the embodiment, when the problem described in Paragraph “Problem to be solved by the Invention” can be solved and the effect described in Paragraph “Effect of the Invention” can be obtained, the configuration from which the constituent requirements have been removed can be extracted as an invention.

According to the present invention, a camera having an optical prism where, even if a targeting object under a low illuminance is captured utilizing infrared rays, an image with color reproducibility can be obtained can be provided.

What is claimed is:

1. A camera comprising:
an optical prism which obtains wavelength spectrum of an optical image of a targeting object;
an infrared ray cutting filter which is set to and retreated from an optical path from the targeting object to the optical prism; and
a plurality of image sensor arranged for respective wavelengths which have been separated by the optical prism, wherein
one of the image sensor has an infrared ray mixture image sensor which convert photoelectric both a specific spectrum and infrared rays, and
an infrared ray separator which separates infrared ray mixture image data output from the infrared ray mixture image sensor into a specific spectrum signal and an infrared ray signal when the infrared ray cutting filter is retreated from the optical path is provided.

2. The camera according to claim 1, further comprising a dummy lens having an optical path length approximately coinciding with that of the infrared ray cut filter, wherein
when the infrared ray cutting filter is retreated from the optical path, the dummy lens is attached onto an optical path positioned between the targeting object and the image sensor.

3. The camera according to claim 1, further comprising
a specific spectrum adjustment section which sets a separation boundary value between the specific spectrum signal and the infrared ray signal from the infrared ray mixture image data,
a white balance adjustment section which adjusts white balance of image data output from the image sensor,
a luminance arithmetic unit which calculates luminance of an image based upon the image data output from the image sensor, and
a chroma arithmetic unit which calculates chroma of an image based upon the image data output from the image sensor.

4. The camera according to claim 3, wherein
the optical prism is a gapless prism where an air gap is not provided between prism members, and
blue wavelength spectrum and green wavelength spectrum are obtained by the gapless prism so that the infrared ray mixture image sensor serves as both a red wavelength image sensor and an infrared ray image sensor.

5. The camera according to claim 3, wherein
the luminance arithmetic unit adjust luminance matrix utilizing a visible light favorite coefficient k.

6. The camera according to claim 3, further comprising
a visible/infrared ratio arithmetic unit which inserts the infrared ray cutting filter to the targeting object to conduct image captured, thereby measuring the specific spectrum signal, removes the infrared ray cutting filter to conduct image captured, thereby calculating the infrared ray signal in a differential manner, and conducts operation of a visible/infrared ratio from the specific spectrum signal and the infrared ray signal, wherein
the specific spectrum adjustment section automatically sets a separation boundary value between the specific spectrum signal and the infrared ray signal based upon the visible/infrared ratio.

7. The camera according to claim 6, wherein
the specific spectrum adjustment section is connected with a specific spectrum adjustment operating section, and the specific spectrum adjustment section conducts input switching between the visible/infrared ratio arithmetic unit and the specific spectrum adjustment operating section.

8. The camera according to claim 7, wherein
the white balance adjustment section is connected with a white balance operating section so that manual adjustment of white balance is performed from the white balance operating section, and when fluctuation of the separation boundary value set by the specific spectrum adjustment section occurs after manual adjustment of the white balance has been conducted from the white balance operating section, the manual adjustment of the white balance is maintained by inputting the fluctuation of the separation boundary value into the white balance adjustment section.

9. The camera according to claim 8, further comprising a color vector adjustment section which conducts color correction manually, wherein
the color vector adjustment section conducts adjustment of at least one of R gain adjustment, Cy gain adjustment, Mg hue adjustment, achromatic adjustment of low chroma saturation Mg, skin color adjustment, green-leaf color adjustment, and blue color adjustment.
